(19) United States
(12) Patent Application Publication
(10) Pub. No.: US 2009/0102418 A1
(43) Pub. Date: Apr. 23, 2009

(54) MANUAL DYNAMO CHARGER FOR RECHARGING PORTABLE ELECTRONIC DEVICES

(76) Inventor: Benny Gaber, Haifa (IL)

Correspondence Address: David Klein;DEKEL PATENT LTD., Beit HaRof'im, 18 Menuha VeNahala Street, Room 27, REHOVOT, IL

(21) Appl. No.: 11/873,487

(22) Filed: Oct. 17, 2007

(51) Int. Cl. H02J 7/00

(52) U.S. Cl. 320/108

(57) ABSTRACT

A manual dynamo recharging device including a roller disposed in a housing and arranged for manually pressing and rolling against a surface, a dynamo connected to the roller, wherein rotation of the roller operates the dynamo to create electricity, and a rechargeable battery electrically connected to the dynamo through electrical circuitry, wherein manually pressing and rolling the roller against the surface operates the dynamo to create electricity to recharge the rechargeable battery, which is electrically connected to an electric portable device battery.

### FIELD OF THE INVENTION

The present invention relates generally to a manual dynamo recharging device, for example, a manual dynamo recharging device that charges a rechargeable battery to recharge an electric portable device battery, such as a cell phone, with or without using a DC to DC converter.

### BACKGROUND OF THE INVENTION

Devices are known for mechanically charging batteries of electronic portable instruments like a cell phone. Such a device serves as a back-up charging device in case there is no wall socket or compatible wall socket electrical charger available.

Examples of such devices include those described in U.S. Pat. Nos. 7,019,492, 7,049,708 and 7,239,237, and US Patent Application 20040204180.

### SUMMARY OF THE INVENTION

In one embodiment of the present invention, a manual dynamo recharging device is provided in which manual dynamo charges a rechargeable battery to recharge an electric portable device battery with or without using a DC to DC converter. The recharging device includes a housing containing a roller attached to a dynamo electrically connected to a rechargeable battery. The rechargeable battery is electrically connected, via a DC to DC converter or directly, to a connector through which a portable electric device battery may be recharged. Manually, using one hand, moving the housing back and forth over a surface, with the roller pressed onto that surface, causes the roller to roll and operate the dynamo, thereby creating electricity to recharge the rechargeable battery of the device.

In yet another embodiment of the present invention, a recharging device including a roller, a dynamo, with or without a DC to DC converter, is embedded in an electric portable device, such as a cell phone. Manually moving the electric portable device back and forth over a surface with one hand, with the roller pressed onto that surface, causes the roller to roll and operate the dynamo to create electricity to recharge the rechargeable battery of the portable device.

There is thus provided in accordance with an embodiment of the present invention a manual dynamo recharging device including a roller disposed in a housing and arranged for manually pressing and rolling against a surface with one hand, a dynamo connected to the roller, wherein rotation of the roller operates the dynamo to create electricity, and a rechargeable battery electrically connected to the dynamo through electrical circuitry, wherein manually pressing and rolling the roller against the surface operates the dynamo to create electricity to recharge the rechargeable battery, which is electrically connected to an electric portable device battery.

In one embodiment, the dynamo creates higher voltage than the recharging battery of the device, thus charging it directly, and the voltage of the rechargeable battery of the device is high enough to recharge the portable device battery directly.

In one embodiment, the electrical circuitry includes a DC to DC converter for converting DC voltage of the rechargeable battery of the device to another DC voltage for the portable electric device battery.

In one embodiment, the electrical circuitry includes a capacitor for storing electricity for recharging the rechargeable battery.

In one embodiment, the recharging device is embedded into an electric portable device, and manually moving the portable device back and forth over the surface with one hand while the roller is pressed and rolled against the surface operates the dynamo to create electricity to recharge a battery of the electric portable device.

In one embodiment, the roller has a removable cover.

In one embodiment, the recharging device has grooves around which a connecting cord is wound and is an integral part of the device.

There is also provided in accordance with an embodiment of the present invention a method for recharging an electric portable device battery including providing a recharging device that includes a roller disposed in a housing and arranged for manually pressing and rolling against a surface, a dynamo connected to the roller, wherein rotation of the roller operates the dynamo to create electricity, and a rechargeable battery electrically connected to the dynamo through electrical circuitry, and using one hand manually pressing and rolling the roller against the surface thereby to operate the dynamo to create electricity to recharge the rechargeable battery, which recharges an electric portable device battery electrically connected thereto.

There is also provided in accordance with an embodiment of the present invention manual dynamo recharging device including a roller disposed in a housing and arranged for manually pressing and rolling against a surface, a dynamo connected to the roller, wherein rotation of the roller operates the dynamo to create electricity, and an electric portable device battery electrically connected to the dynamo through electrical circuitry, wherein manually pressing and moving the roller against the surface operates the dynamo to create electricity to recharge the electric portable device battery. In other words, in this embodiment, the recharger recharges the electric portable device battery without an intermediate rechargeable battery.

### BRIEF DESCRIPTION OF THE DRAWINGS

The disclosed technique will be understood and appreciated more fully from the following detailed description taken in conjunction with the drawings in which:

FIG. 1 is a schematic general front view illustration of a manual recharging device, constructed and operative in accordance with an embodiment of the present invention;

FIG. 2 is a schematic general view illustration of a cell phone equipped with an embedded manual recharging device, constructed and operative in accordance with an embodiment of the present invention, clearly showing a roller used to operate a dynamo;

FIG. 3A is a schematic general front view illustration of the manual recharging device of FIG. 1;

FIG. 3B is a schematic general front view illustration of the manual recharging device of FIG. 1 with its roller being pressed onto a surface;

FIG. 4 is a schematic general view illustration of a charging mode wherein the manual recharging device of FIG. 1 is connected to a cell phone via a connecting cord;

FIG. 5 is a schematic general view illustration of inner parts of the manual recharging device of FIG. 1, in accordance with an embodiment of the present invention;

FIG. 6 is a schematic general view illustration of a manual recharging device, with a cover removed and with a grooved section for a connecting cord; and

FIGS. 7A and 7B are schematic general front view and back view illustrations, respectively, of a cell phone equipped with an embedded manual recharging device, constructed and operative in accordance with an embodiment of the present invention.

### DETAILED DESCRIPTION OF THE EMBODIMENT

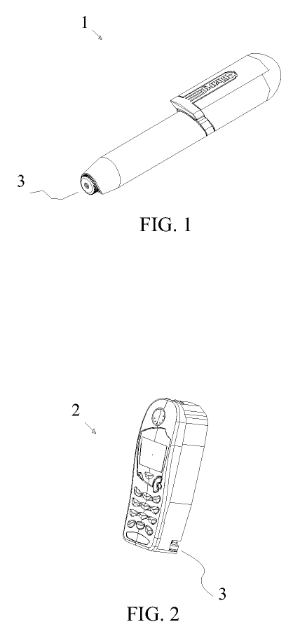

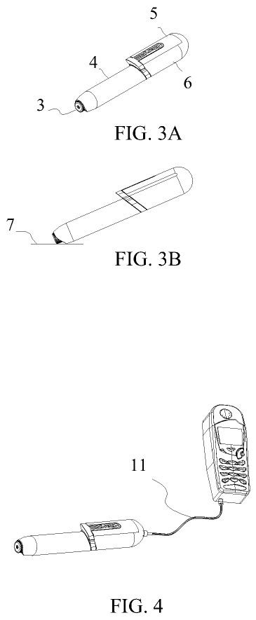

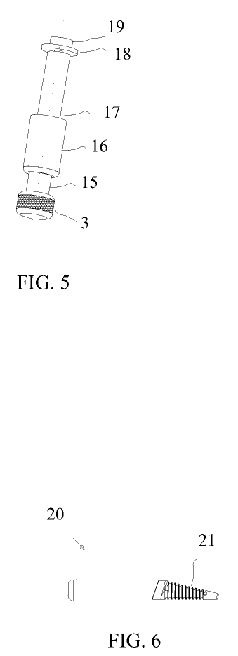

Reference is now made to FIGS. 1, 3A, 3B, 4-6, which illustrate a manual recharging device 1 constructed and operative in accordance with an embodiment of the present invention. The recharging device 1 may have a housing 4 configured in the shape of a “pen” with a pocket clip 5 on a cover 6 (see FIG. 3A). A roller 3 is rotatably mounted at the end of housing 4 and connected to a dynamo 16 (FIG. 5).

As seen in FIG. 3B, manual recharging device 1 is operated by pressing and rolling roller 3 against a surface 7. The rotation of roller 3 operates dynamo 16 to create electricity. As seen in FIG. 5, roller 3 is connected via a shaft 15 to dynamo 16.

A gear may be used to increase the rotation speed of the roller 3 transmitted to shaft 15. Dynamo 16 may be, without limitation, an electromagnetic generator of electricity with a stator and rotor or a DC motor, well known in the art. Rotation of shaft 15, clockwise or counterclockwise, rotates the rotor of dynamo 16 to create an alternating current (AC) or DC voltage, which by utilizing a diode bridge in circuit 18, has the same polarity regardless of the rotation direction of roller 3. As is known in the art, in the case where AC is created by the dynamo, the AC voltage is converted to DC by electrical circuitry 18, such as by a full-wave rectifier that converts the AC voltage into DC voltage regardless of whether the roller 3 turns clockwise or counterclockwise.

The use of roller 3 in the present invention enables a user to generate electricity with one hand, in contrast with cranks of the prior art which require using both hands—one for the crank and the other for holding the device.

Dynamo 16 may be electrically connected to a rechargeable battery 17 and to the electrical circuitry 18 by connection with a socket 19. The electrical circuitry 18 may also include a capacitor or super capacitor for storing electricity for recharging the rechargeable battery 17, or alternatively, for directly recharging the cell phone battery without need for rechargeable battery 17.

The electrical circuitry 18 may include a DC to DC converter for converting the DC voltage of the rechargeable battery 17 to another DC voltage for the portable electric device battery.

FIG. 4 illustrates manual recharging device 1 connected to a cell phone via a connecting cord 11. A long cord 11 may be used to enable using the cell phone while charging it in the same time.

FIG. 6 illustrates the inside of manual recharging device 1 wherein device 1 is formed with grooves 21 around which the connecting cord 11 may be wound.

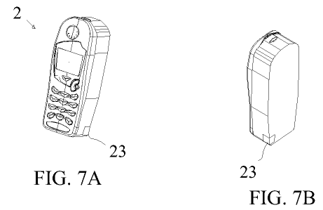

Reference is now made to FIGS. 7A and 7B, which illustrate a cell phone equipped with an embedded manual recharging device 2, constructed and operative in accordance with an embodiment of the present invention. Manual recharging device 2 may be constructed similarly to manual recharging device I with the roller 3 covered by a protective removable cover 23. Here again, rotation of roller 3 operates dynamo 16 (not shown) to create electricity to recharge the rechargeable battery (not shown) of the portable device (cell phone).

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

What is claimed is:

1. A manual dynamo recharging device comprising:
a roller disposed in a housing and arranged for manually pressing and moving against a surface;
a dynamo connected to said roller, wherein rotation of said roller operates said dynamo to create electricity; and
a rechargeable battery electrically connected to said dynamo through electrical circuitry, wherein manually pressing and moving said roller against the surface operates said dynamo to create electricity to recharge said rechargeable battery, which is electrically connected to an electric portable device battery.

2. The recharging device according to claim 1, wherein said electrical circuitry comprises a DC to DC converter for converting DC voltage of said rechargeable battery to another DC voltage for charging the portable electric device battery.

3. The recharging device according to claim 1, wherein said electrical circuitry comprises a capacitor for storing electricity for recharging the rechargeable battery.

4. The recharging device according to claim 1, wherein said recharging device is embedded into an electric portable device, and wherein manually moving the portable device back and forth over the surface causes said roller to be pressed and roll against the surface to operate said dynamo that creates electricity to recharge a battery of said electric portable device.

5. The recharging device according to claim 1, wherein said roller has a removable cover.

6. The recharging device according to claim 1, wherein said recharging device has grooves around which a connecting cord is wound.

7. A method for recharging an electric portable device battery comprising:
providing a recharging device that comprises a roller disposed in a housing and arranged for manually pressing and rolling against a surface, a dynamo connected to said roller, wherein rotation of said roller operates said dynamo to create electricity, and a rechargeable battery electrically connected to said dynamo through electrical circuitry; and
manually pressing and rolling said roller against the surface thereby to operate said dynamo to create electricity to recharge said rechargeable battery, which recharges an electric portable device battery electrically connected thereto.

8. A manual dynamo recharging device comprising:
a roller disposed in a housing and arranged for manually pressing and rolling against a surface;
a dynamo connected to said roller, wherein rotation of said roller operates said dynamo to create electricity; and
an electric portable device battery electrically connected to said dynamo through electrical circuitry, wherein manually pressing and rolling said roller against the surface operates said dynamo to create electricity to recharge said electric portable device battery.

9. The recharging device according to claim 1, wherein said roller is connected to said dynamo by a gear.
